(19) United States
(12) Patent Application Publication
(10) Pub. No.: US 2004/0042949 A1
(43) Pub. Date: Mar. 4, 2004

(54) Method for removing aluminum from chlorosilanes

(76) Inventors: Hans-Dieter Block, Leverkusen (DE); Rainer Weber, Odenthal (DE); Gunter Olf, Leverkusen (DE); Hans-Joachim Leimkuhler, Leverkusen (DE); Johannes-Peter Schafer, Kurten (DE)

Correspondence Address: MCGLEW & TUTTLE, PC, 1 SCARBOROUGH STATION PLAZA, SCARBOROUGH, NY, 10510-0827, US

(21) Appl. No.: 10/416,688

(22) PCT Filed: Nov. 2, 2001
(86) PCT No.: PCT/EP01/12677

(30) Foreign Application Priority Data
Nov. 13, 2000 (DE) 100 56 194.2

(51) Int. Cl. C01B 33/04; B01D 3/00

(52) U.S. Cl. 423/347; 423/342; 203/71; 202/158; 202/174; 203/2

(57) ABSTRACT

The invention relates to a method and a device for separating aluminium from chlorosilanes, in particular for separating aluminium trichloride from silicon tetrachloride or trichlorosilane or from mixtures of silicon tetrachloride or trichlorosilane. According to the invention, aluminium chloride is removed from the chlorosilanes silicon tetrachloride and trichlorosilane in a continuous process, without the addition of admixtures, to obtain a residual content of aluminium that is as low as required, by separating the aluminium trichloride and the chlorosilane by distillation, at a temperature approximately greater than 160° C.

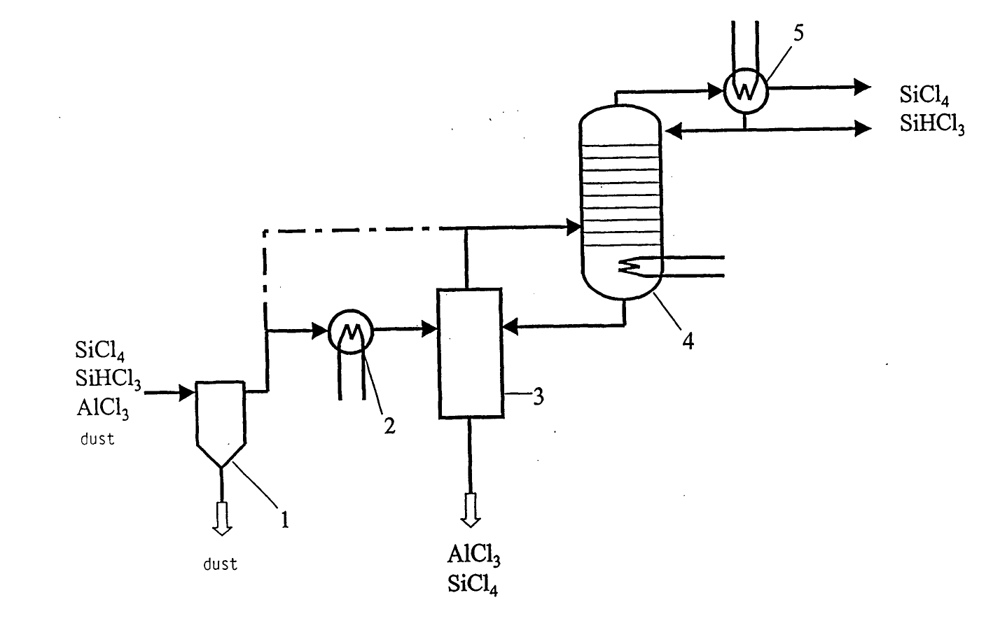

The invention relates to a method for separating aluminium from chlorosilanes, in particular for separating aluminium trichloride from silicon tetrachloride or trichlorosilane or from mixtures of silicon tetrachloride or trichlorosilane.

Trichlorosilane is technically produced by reacting silicon with hydrogen chloride or with silicon tetrachloride and hydrogen. During this reaction, a considerable part of the metallic contaminations contained in the metallurgical silicon are transformed to metal chlorides. Commercial metallurgical silicon provides usually a purity of 90 to 99.3%, the remaining part being mainly iron as well as aluminium in percentages of 0.01 to 0.5%.

Since chlorosilanes are inter alia used for the preparation of high-purity silicon, the metal chlorides must be separated possibly completely. The produced iron chloride is separated mechanically by means of a cyclone or a gas filter; separating the aluminium trichloride, however, is more difficult because of its high volatility (sublimation temperature 178° C.).

The problem of separating aluminium from chlorosilanes (STC) and trichlorosilane (TCS) and from mixtures thereof occurs in all steps of purifying the said chlorosilanes by distillation, the aluminium being provided in these media almost exclusively in form of aluminium trichloride. The existence of aluminium chloride is to be attributed to the contents of silicon used for the production of chlorosilanes of some hundred to some thousand ppm. In the synthesis step of the chlorosilanes silicon tetrachloride and trichlorosilane metallurgical silicon of different silicon contents and possibly containing considerable iron percentages, is reacted with hydrogen chloride or with mixtures of silicon tetrachloride and hydrogen chloride at increased temperatures. During this reaction the aluminium contained transforms to aluminium trichloride. The latter is volatile together with the chlorosilanes.

The existence of aluminium trichloride, which is almost insoluble in the said chlorosilanes on the one hand (the solubility is only some few ppm of the ambient chlorosilanes medium at ambient temperature)—and which, on the other hand, provides a considerable vapour pressure (above the solid, crystalline aluminium chloride called sublimation pressure), causes the solid aluminium to spread via the gas space all over the distillation apparatus. The consequences are on the one hand the failure of the separation by distillation of aluminium from chlorosilanes, on the other hand the deposition of sublimed aluminium chloride on the distillation apparatus. The latter is particularly problematic for the continuous distillation of the said chlorosilanes, since the permanent refilling of aluminium chloride containing liquid leads to a growing deposition of solid aluminium chloride forcing the interruption of the process.

Many attempts have been made to remove this problem in order to achieve an unobstructed distillation of the said chlorosilanes.

The distillation of the said chlorosilanes can be carried out at reduced temperatures in a vacuum. Under these conditions, the vapour pressure of solid aluminium chloride is so low that its percentage can decrease below the solubility level in the gaseous phase, thus avoiding the problem of solid aluminium chloride depositing in the apparatus. However it is not possible to lower the aluminium chloride percentage below its vapour pressure percentage of the total vapour pressure, so that on the one hand the separation of aluminium is possible only to a limited extent, on the other hand the problem of aluminium chloride deposition occurs anew during renewed distillation, although in reduced amounts.

A partial solution of the problem was achieved also by the method specified in DE-OS 21 61 641, in that the gas stream leaving the synthesis reactor is cooled down in two steps by feeding silicon tetrachloride, first to approx. 250 to 300° C. and afterwards in a Venturi washer applying further silicon tetrachloride to approx. 53° C., wherein components carried along by the chlorosilanes, e.g. iron chloride and aluminium chloride, are deposited and remain in the condensate and the gas stream containing the essential part of chlorosilanes is again washed with condensed chlorosilanes and can be condensed thereafter. The remaining contents of aluminium chloride is then given by the vapour pressure of the aluminium chloride at approx. 53° C. During the further purifying of chlorosilanes by distillation the above specified problem of aluminium chloride concentrating in the bottoms occurs again, with the consequence of the formation of a solid phase of aluminium chloride and the undesired sublimation of aluminium chloride.

The above specified methods do not only have the disadvantage that they do not provide any solution to the said problem, however, they do neither permit to use the energy that is contained in the gas stream in form of heat, e.g. for the generation of water-pressure steam. However, at least the specified methods enable to realise a continuous reaction process.

According to the state of the art physical operations are not sufficient for a further removal of aluminium chloride, this requires chemical reactions. This comprises the addition of admixtures, e.g. oxygenic species of silicon, generally called siloxanes, mostly generated in situ by adding water, oxygen, ketals etc. of amines and other monomers and polymers providing combining capacity, which bind the aluminium chloride and to a certain extent also other contaminations in a way ensuring that it remains bound to a mechanically separable solid phase or does not cause problems in the gaseous phase. It was also suggested to separate aluminium chloride selectively by guiding the gas stream across or through solid sodium chloride which renders the aluminium chloride easily separable by distillation.

The object of the invention is therefore to provide a method for removing aluminium from chlorosilanes, wherein aluminium chloride is removed from the chlorosilanes silicon tetrachloride and trichlorosilane in a continuous process, without the addition of admixtures, in order to obtain a residual content of aluminium that is as low as required.

This object is achieved by separating the aluminium trichloride and the chlorosilanes by distillation at a temperature approximately greater than 160° C. The distillation temperature can be up to approx. 220° C. as the upper limit, however working temperatures of approx. 190° C. to 200° C. are preferred.

Preferably the distillation process is carried out in a multistage column. This way it is possible to obtain chlorosilanes which are free from aluminium chloride, i.e. silicon tetrachloride, trichlorosilane or mixtures thereof, at the head of the column, to collect aluminium chloride in a non-solid form in the bottoms of the column and to operate the distillation apparatus, particularly so the column, without problems caused by depositions (baking) permanently and continuously.

Aluminum chloride provided in the form of a concentrated solution in the chlorosilanes as a liquid can be removed easily from the bottoms of the column continuously, intermittently or discontinuously, preferably through a pressure release apparatus. The bottoms contains between approx. 1% and approx. 98% aluminium chloride, the concentration degree is freely selectable depending on the temperature. The pressure in the distillation apparatus is linked with the applied distillation temperature by the vapour pressure of the chlorosilane components, it is in a working range between approx. 25 to approx. 40 bar.

The method according to the invention can be particularly applied in processes for the manufacture of silane and in processes for the manufacture of hyper-pure silicon from silane.

A particularly suitable method for the manufacture of silane comprises the steps

1. Trichlorosilane synthesis on the basis of silicon, silicon tetrachloride, hydrogen and, if necessary, another chloride source in a fluidized bed reactor under pressure and subsequent isolation of the produced trichlorosilane by distillation and recycling of the unreacted silicon tetrachloride, and, if desired, the unreacted hydrogen.

2. Disproportionation of trichlorosilane to silane and silicon tetrachloride through the intermediate stages of dichlorosilane and monochlorosilane on basic catalysts, preferably catalysts containing amino groups, carried out in two apparatuses or in one, and recirculation of the produced silicon coming out as a high-boiling component into the first reaction area.

3. Further use of the silane of the purity given after the preceding step, or purifying the silane until the purity required for the intended purpose is achieved, preferably by distillation, particularly preferred by distillation under pressure.

The method for the manufacture of hyper-pure silicon from silane, preferably produced in accordance with the above specified steps, consists in the thermal decomposition of silane, usually above 500° C.

Apart from thermal decomposition on electrically heated high-purity silicon rods, another suitable method is the thermal decomposition in a fluidized bed consisting of hyper-pure silicon particles, particularly when the production of solar-grade high-purity silicon is desired. To this aim, silane can be mixed with hydrogen or inert gases at a ratio of 1:0 to 1:10.

The invention will be explained in the following by means of a drawing depicting a preferred embodiment. The invention is to no extent limited, however, to the embodiment represented in the drawing. The only FIGURE provides a schematic illustration of the apparatus according to the invention as well as of the method according to the invention.

The pressurised hot product gas stream P coming out of the chlorosilanes reactor with a temperature from 320° C. to 1000° C. from is cleaned from dust in a cyclone or in several cyclones 1 which are connected in series and, if desired, is subsequently cooled down to approx. 180 to 300° C. in a cooling apparatus 2. Cooling is achieved preferably by contact with heat exchanging surfaces under transfer of the energy content. Afterwards either at part of the gas stream is condensed under transfer of further energy including condensation heat on the heat exchanging surfaces of a separator container 3 via a liquid phase, essentially comprising silicon tetrachloride and high-boiling components, or it is introduced in gaseous form in the bottom or middle part of a distillation column 4 or in the bottoms of the said distillation column 4 where afterwards aluminium chloride as a highboiling substance is separated from chlorosilane in the interior of the said column 4. The liquid chlorosilanes are obtained at the head of the column 4 and, if necessary, purified further from other polluting components, or they are used for their intended purpose. The gas extracted at the head of the column 4 is condensed at a condenser 5.

Both condensation steps in the preferred embodiment can also be combined in one step, e.g. by introducing the hot product gas stream immediately in the distillation apparatus, as it is implied by the dot-dashed line.

The distillation column 4 in the embodiment comprises preferably between 4 and 60 theoretical bottoms (named in the only FIGURE), either as tower packings, fabric packing or as distillation bottoms, wherein in the bottom part of the column 4 self-purifying bottoms are preferred.

1. A method for separating aluminium from chlorosilanes, in particular for separating aluminium trichloride from silicon tetrachloride or trichlorosilane or from mixtures of silicon tetrachloride or trichlorosilane, characterised in that the aluminium trichloride and the chlorosilanes are separated by distillation at a temperature higher than approx. 160° C.

2. A method according to claim 1, characterised in that the temperature during the distillation process is between approx. 190° C. and approx. 200° C.

3. A method according to claim 1 or 2, characterised in that the pressure during the distillation process ranges from approx. 25 to approx. 40 bar.

4. A method according to any one of claims 1 to 3, characterised in that the method is applied in processes for the manufacture of silane and/or hyper-pure silicon from silane.

5. An apparatus for the execution of the method according to at least one of claims 1 to 4, wherein the distillation is carried out in a multistage column (4).

6. An apparatus according to claim 5, wherein the distillation column comprises between 4 and 60 theoretical bottoms.

7. An apparatus according to claim 6, wherein the theoretical bottoms are formed as tower packings, fabric packing or as distillation bottoms.

8. An apparatus according to claim 6 or 7, wherein at least the lower theoretical bottoms are self-purifying distillation bottoms.
